(19) United States
(12) Patent Application Publication
(10) Pub. No.: US 2015/0310182 A1
(43) Pub. Date: Oct. 29, 2015

(54) DATA PROCESSING AND COMMUNICATION UNIT FOR RECORDING PATIENT DATA IN THERAPY-FREE INTERVALS

(71) Applicant: B. BRAUN AVITUM AG, MELSUNGEN (DE)

(72) Inventors: JANOSCH HENZE, KASSEL (DE); CHRISTOF STROHHOEFER, KASSEL (DE)

(21) Appl. No.: 14/688,507

(22) Filed: Apr. 16, 2015

(30) Foreign Application Priority Data
Apr. 28, 2014 (DE) 10 2014 105 916.6

(51) Int. Cl. G06F 19/00

(52) U.S. Cl. CPC G06F 19/3418; G06F 19/322

(57) ABSTRACT

A patient data monitoring system is disclosed for central monitoring of vital parameters of at least one dialysis patient in a therapy-free interval. The system includes a central patient database for storing patient data, at least one measuring device carried along or kept at home by a patient during the therapy-free interval, and a portable data processing and communication device carried along or kept at home by the patient in the therapy-free interval that assigns a corresponding patient ID to each measured vital parameter received from the at least one measuring device via data communication, automatically sets up a remote data connection to the central patient database and, once the connection to the central patient database is set up, automatically transmits a data set including patient ID and the at least one measured vital parameter to the central patient database.

### CROSS REFERENCE TO RELATED APPLICATIONS

This application claims priority to German application DE 10 2014 105 916.6 filed Apr. 28, 2014, the contents of such application being incorporated by reference herein.

### FIELD OF THE INVENTION

The present invention relates to the field of medical apparatuses, especially to a patient data monitoring system for central monitoring of at least one vital parameter of at least one dialysis patient in the therapy-free interval and to a method of central monitoring of at least one vital parameter of at least one dialysis patient in the therapy-free interval.

### BACKGROUND OF THE INVENTION

It is important for the physician to know the course of a patient's vital parameters so that he/she can provide the patient with the best possible dialysis therapy. However, frequently the physician only has vital parameters at times at which the patient undergoes treatment (e.g. in the dialysis center). Hence the physician is in need of information over the interval during which the patient is at home or on vacation so as to be able to offer optimum therapy to the patient.

Currently, nephrologists are not easily in a position to record data of patients, such as blood pressure or weight, outside the interval in which the patient requires dialysis and to observe the course thereof. Such information about the vital parameters of the patients would contribute to improving the treatment of the dialysis patient. At present, these data are either not available at all or are available only in time-consuming cooperation of the patient. Although there are measuring devices that are adapted to record patient data in the dialysis-free interval and have an interface which enables measuring data to be read out. However, it is not possible to send data via said interface directly to a central station, e.g. the dialysis center, or to record and compare them over a longer period of time.

### DESCRIPTION OF THE RELATED ART

US 2013/0211 206 A1 describes the operation of data recording during dialysis therapy. The recorded data are collected and processed. The processed data then can be utilized for improving subsequent therapies.

US 2010/0056 878 A1 describes a mobile device capable of retrieving the health status of the patient via sensor measurements. The mobile device is connected to a sensor fixed to the body and from there collects the data.

US 2009/0306 573 A1 describes an apparatus for recording sensor data of the dialysis machine and transmission thereof to a server (remote-host). The dialysis machine has a bi-directional wireless Internet connection via WIFI to a gateway. Said gateway in turn is connected to a remote server (remote host). Via this connection data relating to therapy are transmitted from the dialysis machine to the remote server. It is also possible to receive data for the control of the dialysis machine which are transmitted from the remote server. In this case the data are not collected in a therapy-free interval, nor is a mobile data collection concerned.

US 2008/0294 058 A1 describes a system for measuring the pulse of a patient. The system comprises a server, a sensor and a mobile device constituting an interface between the sensor and the server. The measurement is to be carried out via the sensor (the pulsometer). The control of the pulsometer is performed by the mobile device which then transmits the data to the server.

US 2012/0035534 A1 discloses a system which is adapted to record data within the scope of dialysis and transmits the data obtained wirelessly to a central data memory. The system is encoded with an identification which enables the transmitted data to be assigned to the particular patients. By way of the data in the central data storage unit an ultrafiltration rate can be adjusted.

For successful measurement the patients usually have to carry out a number of interactions such as starting measurement, storing and transmitting the data, confirming input information and/or assigning patient data to the measuring value. The previously employed systems and devices therefore are largely configured to be used merely by single persons. Hence, if more than one patient make use of the system, an unambiguous assignment of measuring data to the patient is not easily possible. It is an imaginable scenario, for example, that in one household there are two dialysis patients whose vital parameters are to be monitored. Unless a separate data recording device shall be made available to each individual patient, which, of course, is cost-intensive, it is of advantage to use only one data recording device. In this case the assignment of the data to the correct patient has to be enabled. This assignment is preferably performed automatically or at least involving little interaction of the patient. Therefore, in the case of wrong assignment in the worst case it can happen that a measured vital parameter is assigned to a wrong patient, which then may result in wrong treatment.

Furthermore, several devices only support proprietary measuring devices or measuring devices certified for the particular manufacturer. This means that measuring devices of different manufacturers available on the market cannot easily cooperate with a different system, because the protocols used, for instance between the transmitter and the receiver, do not match or require a particular interface or periphery. Frequently, those systems are moreover fixedly installed, are not portable, only record data during therapy (during dialysis) and provide no recommendations for treatment to the attending physician.

### SUMMARY OF THE INVENTION

It is an object of the present invention to avoid the afore-mentioned drawbacks, especially the problems occurring with the use of the data processing and communication means (data box) in a two or more person household and to provide a method which permits recording of vital parameters of at least one patient in a therapy-free interval without the patient staying in the vicinity of the dialysis center or a dialysis apparatus, assigns the data unambiguously to a patient and stores and makes available the data in a central patient database.

The patient data monitoring system for central monitoring of at least one vital parameter of at least one dialysis patient in the therapy-free interval comprises a central patient database for storing patient data which can be viewed at any time by physicians, hospital staff members and/or the particular patient via a communication interface. Furthermore, it includes at least one measuring device carried along by a patient or kept at home in the therapy-free interval for measuring at least one vital parameter of the at least one patient, wherein a data processing and communication means carried along by the at least one patient or kept at home in the dialysis-free interval which assigns to each measured vital parameter received from the at least one measuring device via data communication a corresponding patient ID consisting e.g. of the name of the patient, an entered sequence of figures, a personal key or similar personalizing features, automatically establishes a remote data communication with the central patient database and, once the connection to the central patient database is established, automatically transmits a set of data consisting of the patient ID and the at least one measured vital parameter to the central patient database.

The storage of the data at a central station enables the attending physician to include the course of the stored values over the period of the dialysis-free interval for optimizing the treatment. It is possible to record the patient data (vital parameters) with the aid of data processing and communication means. The data are recorded via an interface of the data processing and communication means communicating with an interface of the measuring devices.

The measuring device transmits the measured vital parameters to the data processing and communication means. In the data processing and communication means at the latest the data can be automatically assigned to information for identifying the patient (patient ID), e.g. patient number, insurance number, name (with date of birth, where necessary).

Thus the data processing and communication means is configured so that an unambiguous assignment of measured vital parameters and the particular patient to a patient ID can be ensured in case that the data processing and communication means is used by more than only one single patient for central monitoring of vital parameters, for example in a two or more person household in which the vital parameters of two patients are to be monitored. The data processing and communication means is adapted to assign the recorded data to a particular patient.

In order to perform automatic assignment of patients each patient who intends to make use of the data processing and communication means has to register with the data processing and communication means once, for example via an appropriate data input device such as a keyboard, a touchscreen or a different device suited for this purpose. This can be done, for instance, by entering one's name and/or a password. In this way, the patient is permanently stored as user for the data processing and communication means. Alternatively, a personalized key can be installed for establishing a safe connection to the server on the data processing and communication means. Further possible methods for identifying a patient in the data processing and communication means consist in replying to a question or in that the patient has to confirm the measurement made. (If necessary, the patient is requested to change the user.)

In accordance with an aspect of the invention, the patient data can be intermediately stored in the data processing and communication means, until the data processing and communication means is capable of establishing a connection to the Internet and of transmitting data to a central server or decentralized server architecture.

An attending physician, a nurse or the patient him-/herself can recall the data. The attending physician or the nurse is thus informed, e.g., about the weight increase or the blood pressure progression of the patient.

The data processing and communication means can be a software application on a smart phone or a tablet PC. A data processing and communication means can also be in the form of an independent hardware platform, however.

For establishing the Internet connection, the data processing and communication means makes use of the means available such as a mobile radio connection, a WIFI connection or any other suitable connection allowing a connection for data transmission via the Internet.

Moreover, the data processing and communication means can be configured so that it permits communication with a plurality of different measuring devices or measuring sensors. This is advantageous in case that measuring devices and/or sensors of different manufacturers are used, for example. Not all measuring devices and/or sensors do have the same interface with the data processing and communication means. For example, a measuring device can communicate with the data processing and communication means via Bluetooth interface, while a different one includes a WIFI or infrared interface. In addition, the data processing and communication means may use an abstraction layer (device abstraction layer) acting like an interface and enabling communication with the most various measuring devices and sensors, if these devices have different data formats. The abstraction layer establishes from the data flow of the connected sensors the measuring values and the type of sensor/measuring device (scales, blood pressure instrument etc.) concerned.

In accordance with the further development of measuring devices and sensors, the abstraction layer can be adapted to new measuring devices and sensors and, respectively, new data formats (protocols), for example via software updates downloaded via the Internet. This enables most various measuring devices to communicate with the data processing and communication means, e.g. blood pressure instrument, scales, blood sugar meter, clinical thermometer, step counter, body fat instrument, cholesterol instrument, instrument for body fluid, bioimpedance instrument, urine specimen instrument, blood count instrument, instruments for the analysis of body fluids and/or breath.

Furthermore, the data processing and communication means can be configured to implement automatic identification of a patient by way of biometric data. Linking the vital parameters obtained from a measuring device for measuring the vital parameters with biometric data of the patient permits unambiguously identifying the patient and assigning the patient to the person whose vital parameters were recorded. Biometric data can be, for example, iris scans, face recognition, voice recognition or a finger print. A combination of one or more such parameters is equally possible and advantageous to an unambiguous identification.

The data processing and communication means can further be equipped with the appropriate means to record these afore-mentioned biometric parameters, such as a finger print scanner/sensor, a camera for face recognition or means for voice recognition.

Another variant of the method of identification by way of biometric data resides in the fact that via existing measuring values a data curve of the patient is trained with “artificial intelligence”, i.e. a “finger print” of his/her vital parameters is established. With the aid of the trained data a patient then is unambiguously identified. This analysis of the measuring values is carried out on the database server, as only here the appropriate computing power is available. From the analysis computed on the server the data processing and communication means obtains a set of data which is retained on the data processing and communication means and is characteristic of the particular patient. For each user of the data processing and communication means such characteristic set of data is stored. When a measurement arrives at the data processing and communication means, it is compared to the characteristic data sets. If coincidence is found, the measuring value can be unambiguously assigned to the patient.

If no means for detecting biometric data are provided or if they are defective, manual input is always chosen as “fallback” solution for the purpose of identification.

The data processing and communication means may include means which enable information on location and time to be recorded and which thus add information about the time of measurement and/or the place of measurement to the patient data. Suitable means for localizing are, for example, GPS receivers or other localizing means which may be integrated in the data processing and communication means. The established information about location and/or time can be added as metadata to a set of data consisting of vital parameters of the patient and data which unambiguously assign the patient to the vital parameters measured. This can be advantageous when, for example, the patient stays at locations of varying environmental conditions, such as on vacation in hot, cold or humid environment. Should any abnormalities occur in the measuring values, it might be useful to know where the patient stays or stayed during measurement of the vital parameters so as to adapt the therapy to the particular conditions, where appropriate.

The data processing and communication means can be designed to be both stationary and portable. This enables plural patients to share a data processing and communication means. A portable data processing and communication means can interact or communicate with or via a current smart phone, tablet PC or laptop.

In addition to the data processing and communication means, a method is disclosed by which central monitoring of at least one vital parameter of at least one dialysis patient is possible in a dialysis-free interval.

In a first step a connection is established between a sensor or a measuring device for measuring at least one vital parameter and a data processing and communication means. After establishing the connection, a vital parameter of a patient can be measured in the therapy-free/dialysis-free interval. Measuring parameters can be blood pressure, weight, blood sugar, body temperature, physical activity, body fat, cholesterol level, share of body fluid, bioimpedance, urine, blood count and/or analysis of body fluid and/or breath. After measuring one or more vital parameters a transmission to the data processing and communication means is carried out. After completed transmission, in the data processing and communication means a patient ID is assigned to the measuring value/vital parameter so as to obtain an unambiguous linking of the measuring value/vital parameter with the patient. In another step the data processing and communication means automatically checks whether connection to the Internet can be established so as to establish a remote data communication with a central patient database. If it is found that a connection can be set up, the data processing and communication means automatically establishes a remote data communication with a central patient database. When the connection to the central patient database is established, a set of data consisting of patient ID and the at least one measured vital parameter is automatically transmitted from the data processing and communication means to the central patient database.

In the central patient database the set of data is stored as patient data set and can be viewed at any time by physicians, hospital staff members and/or the particular patient via a communication interface.

In an additional step it may be required for the patient to register once with the data processing and communication means. Already during measurement of the vital parameters an identification of the dialysis patient can be transmitted, if a measuring device/sensor is appropriately configured.

The measuring device/sensor then has an identification which can be used to identify the patient and is transmitted along with the measuring value to the data processing and communication means. This option may be useful when the data processing and communication means is used by one single person. In this case, too, manual input is always provided for legitimation of the patient as a “fallback” solution, unless there is any other possibility for identification.

In an alternative step the assignment of the data to a patient can be carried out by means of detecting biometric data of the patient and assigning the ID according to the detected biometric data. The data processing and communication means can make available the means required to record these data (finger print scanner, camera for face recognition etc.).

The data can be intermediately stored in the data processing and communication means and, after successful transmission to the central patient database, can be deleted from the data processing and communication means.

Additionally, metadata can be added to the set of data of the patient consisting of vital parameters and ID information by the data processing and communication means, wherein the metadata may contain time and/or location data. The data processing and communication means includes the means required to add these data to the patient data set.

In a further step the data processing and communication means can encode the data of the data set consisting of patient ID and vital parameters. Alternatively or additionally, the data processing and communication means can establish a safe connection to a database server (central patient database). Both measures are of advantage regarding the fact that the data are related to persons and are relevant as regards data privacy.

If the transmission of the set of data to the central patient database fails for any reason, the data processing and communication means automatically initiates a repeated establishment of connection until successful transmission has taken place.

According to the patient data stored on the patient server, with the aid of data analysis technologies a recommendation of treatment can be given to the physician. This recommendation of treatment can assist the physician, the nursing staff or else the patient during dialysis. By way of the data collected a lot of treatment recommendations assisting the treatment can be given to the physician or the nursing staff. These include, among others: recommendation of the ultrafiltration profile based on blood pressure measurements from at home; recommendation of the ultrafiltration volume based on increased body fluid; recommendation of a particular concentrate; recommendation of a particular conductivity profile; recommendation of a particular conductivity/Na concentration; recommendation of a particular diet; recommendation of a particular dialysis fluid flow; recommendation of a particular blood flow; recommendation of a particular dialyser; recommendation of a particular medicine; recommendation of a particular dose of heparin; recommendation of a particular EPO dose; recommendation of a particular phosphate binder; recommendation of a particular setting; and/or recommendation to use a particular option of the dialysis machine such as BioLogic RR treatment, when frequent and strong blood pressure drops are detected so as to counteract the same in order to avoid hypotensive episodes during dialysis.

These recommendations can be determined or expressed on the basis of the data collected during the dialysis-free interval and, respectively, on the basis of all data existing for the particular patient in the database. This can also include data relating to the therapy. The data analysis is started upon receipt of a newly measured vital parameter of a patient. Depending on the type of measuring value (blood pressure, weight, blood sugar) an analysis process can be started as a function of the vital parameter measured. The analysis process determines former measuring values of the same type and the same patient on the basis of the vital parameter measured. It is attempted with particular mathematic methods (mean value, standard deviation, variance, frequency information (FFT=Fast Fourier Transformation)) to determine special features of these data.

After that a model is adapted, is applied to the value or a prediction and/or classification is performed. Based on this processing step, a treatment recommendation is established which can be stored in a next step in the patient database. The stored treatment recommendations can be displayed to the attending physician when he/she recalls the patient data next time or when he/she explicitly requests the treatment recommendations. Also the patient or the attending staff can be enabled to view the treatment recommendations.

### BRIEF DESCRIPTION OF THE DRAWINGS

The invention is best understood from the following detailed description when read in connection with the accompanying drawings. Included in the drawings are the following figures:

FIG. 1 shows the structure of a data processing and communication means (data box) including connected devices;

FIG. 2 shows a flow chart of a measuring process;

FIG. 3 shows a flow chart of a patient's inquiry; and

FIG. 4 shows a flow chart of a physician's inquiry;

FIG. 5 shows the process concerning a treatment recommendation;

FIG. 6 shows the analysis unit on the server.

### DETAILED DESCRIPTION OF THE PREFERRED EMBODIMENTS

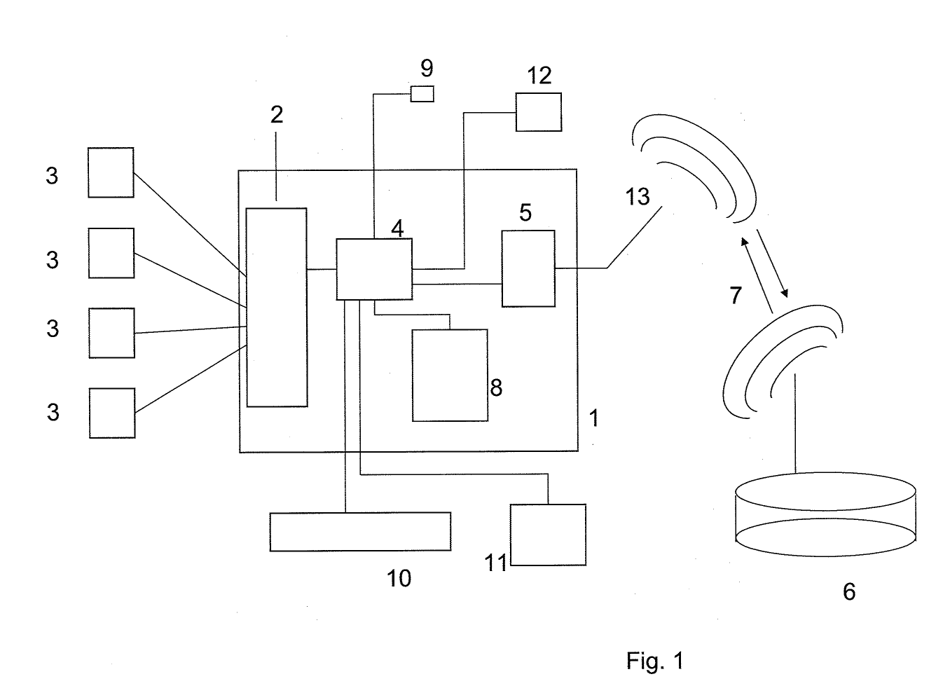

FIG. 1 shows the structure of a data processing and communication means 1 (hereinafter merely referred to data box 1). One or more measuring devices 3 record vital parameters of a patient. The measuring devices 3 can be most different measuring devices such as scales, a blood pressure instrument or other measuring devices for vital parameters.

The one or else plurality of the measuring devices 3 is/are coupled to the data box 1 via wireless or wire-bound connection. The data box 1 receives the vital parameters of a patient measured and transmitted by the measuring devices 3.

Before the measuring data from the measuring device 3 are further processed in the data box 1, a device abstraction layer 2 ensures that the measuring data incoming from the measuring device 3 have a data format adapted to be further processed by the data box 1. Since the measuring device(s) 3 may originate from different manufacturers, it is not always provided that the data format, for example of weight measuring devices (scales) of two different manufacturers, is equal. For this, the data box 1 is provided with a device abstraction layer 2. The device abstraction layer 2 is configured to receive different data protocols from measuring devices 3 of different manufacturers and to convert them to a data format which is adapted to be further processed by the data box 1.

After passing the device abstraction layer 2, in a data processing unit 4 identification data which allow unambiguous assignment of the patient to his/her measured vital parameters are added to the vital parameters.

In the simplest case the patient has registered with the data box 1 via a keyboard 10, for example by his/her name and/or a password which solely the patient knows. The data processing unit 4 generates, along with the vital parameters, a personalized data set of the patient by these data.

The data box 1 optionally has further possibilities of automatically assigning the measured vital parameters to a patient so as to carry out assignment of the vital parameters to the patient in a biometric manner. A camera 9 which (optionally) is communicated with the data box 1 performs face recognition or iris recognition. By way of these biometric data an unambiguous assignment to the patient can be made. Analogously the identification is performed with a finger print via an (equally optional) finger print sensor 11.

In another variant, metadata are additionally added to the data set. Said metadata are, for example, data of location, time or other information that are important in connection with the vital parameters. The data of location are received by a GPS receiver 12 connected to the data box 1 or by another device suited for this purpose. These data of location are further added to the data set consisting of vital parameters and identification data in the data processing unit 4.

The complete set of data is encoded by the data processing unit 4 and is intermediately stored in the memory 8.

The data box 1 now establishes a connection to the Internet 7 by the means for detecting and establishing the Internet connection 5 so as to get connected to the patient server 6. If required for reasons of the connection quality, optionally an antenna 13 connected to the data box 1 is additionally used for establishing the connection.

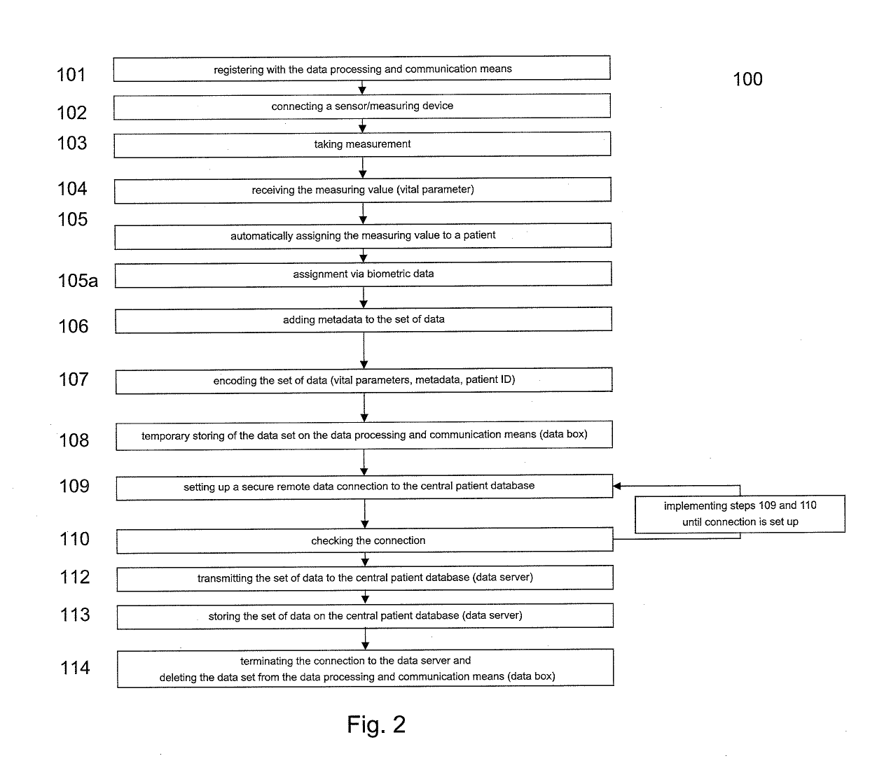

The process of a measurement and of a transmission operation is illustrated in FIG. 2 in the form of a flow chart.

First the patient registers with the data box 1 in step 101. In step 102 one or more measuring devices 3 which the patient keeps are connected to the data box 1. This is done either wire-bound or wireless. In step 103 the patient carries out the measurement (weight measurement, blood pressure etc.). In step 104 the data box 1 receives the measuring data (vital parameters) from the measuring device 3.

Since in step 101 the patient has registered him-/herself, the patient is automatically assigned to the measuring data 105. Alternatively, when plural users share a data box for receiving their data, in step 105a automatic identification of a patient can be effected via biometric data. As an alternative, when plural users share a data box 1 for receiving data and no means for biometric identification are provided or are applicable for any reason, identification can also be effected by manual input. For this, each user can enter his/her personal data prior to measurement of his/her parameters, for example via a keyboard connected to the data box 1, and can confirm that the data being measured now have to be assigned to his/her person. Then the data box 1 can be configured so that the manual identification is generally required in the case of non-existing or non-functioning biometric sensors.

In step 106 (optionally) metadata such as location data, time data (of the measurement) or other data relevant to the physician are added. For safety reasons or reasons of data privacy in step 107 the entire set of data consisting of measured vital parameters, identification data and metadata is encoded and is intermediately stored in a storage area 8 of the data box 1 in step 108.

In step 109 the data box 1 starts to establish a data connection to the central patient database and checks the connection 110. Optionally, unless the connection can be established, in step 111 the course of steps 109 and 110 is repeated until a connection is established. If, for example, the patient for any reason has no Internet access at home or the Internet access is disturbed, a new attempt to connect is started, when the patient stays with his/her data processing and communication means at an appropriate location for establishing a connection to the Internet.

When a connection is established, in step 112 the intermediately stored data set is transmitted to the central patient database (data server) 6 and is stored there in step 113. In step 114 the connection to the server is terminated after successful transmission and the intermediately stored data set is deleted from the data box 1.

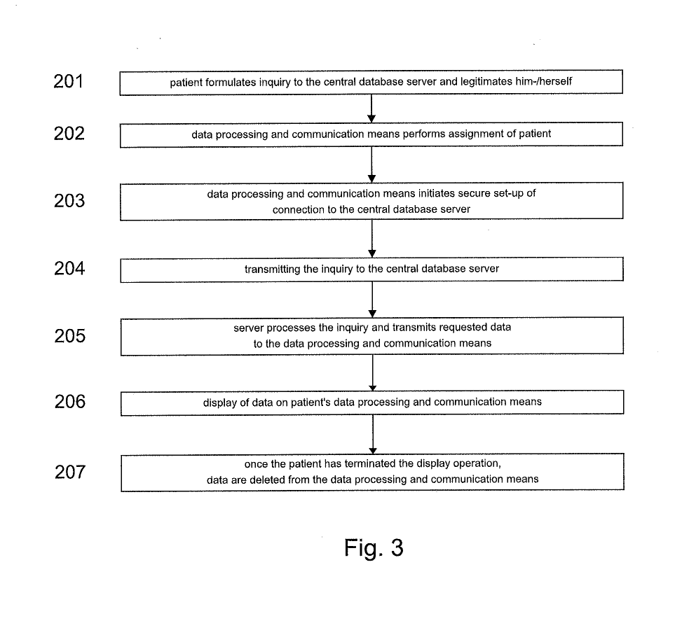

FIG. 3 shows the progression of a patient inquiry to the central database server.

For example, a patient wants to view the latest records of his/her blood pressure with the aid of his data box 1. For this purpose, the patient formulates an inquiry with the aid of appropriate input means in the data box 1, wherein he/she also legitimates him-/herself with respect to the central patient database 6 by input of his/her personal data (step 201). By way of the legitimation data input by the patient there follows assignment of the patient (step 202). The data box 1 now initiates set-up of the connection to the Internet (step 203). When the connection is established, the inquiry is sent to the central patient database server 6 via a secure connection (step 204). The central patient database server 6 processes the inquiry and transmits the data via the secure line to the data box 1 which now reports successful receipt to the central patient database server 6 (step 205). The connection to the central patient database server 6 then is terminated. The data are graphically displayed according to the possibilities of the data box 1 (step 206). After successful viewing of the data they are deleted again (step 207).

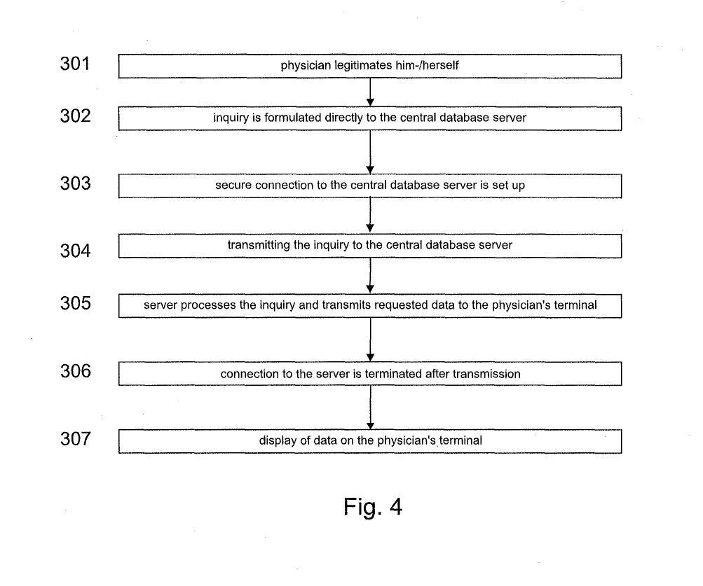

FIG. 4 illustrates a process during inquiry of the data by a physician. This inquiry is largely similar to the data inquiry by the patient. A physician wants to observe, for instance, the data of a patient during the dialysis-free interval. The physician stays in the dialysis center and from there has direct access to the central patient database server 6, for example via a computer at his/her workplace. After the physician has legitimated him-/herself with respect to the central patient database server 6 (step 301), he/she formulates an inquiry to the central patient database server 6 with the aid of a software (step 302), he/she wants to view, e.g., the weight increase of the patient, since the latest treatment. After successful formulation of the inquiry and corresponding legitimation, a secure connection is set up to the patient database server 6 (step 303) and the inquiry is sent to the central patient database server 6 (step 304). The patient database server 6 processes the inquiry and returns the data to the physician (step 305). After successful transmission of the data to the physician, the connection is terminated (step 306) and a graphic progression of the data is displayed to the physician (step 307).

Instead of the afore-mentioned Internet connection between the data box 1 and the central patient database 6 also mobile radio communications can be used for the data exchange.

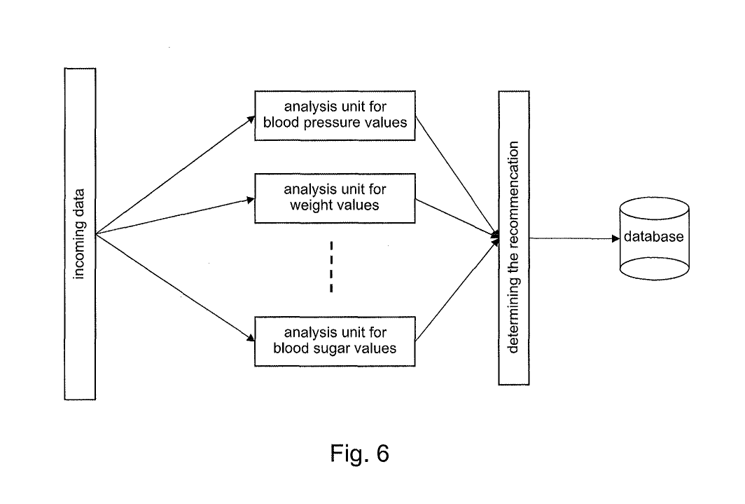

A possible analysis/recommendation unit on the server is depicted in FIG. 6. It shows the division of the data depending on the measured value. The analysis is performed on the basis of the detected type of measuring value. The treatment recommendation can also incorporate values from other analyses, e.g. also values collected during a therapy and equally stored on the patient server/patient database server 6. Then a detected treatment recommendation which is automatically transmitted to the physician upon recalling the patient data or which he/she can explicitly recall is stored in the patient database 6.

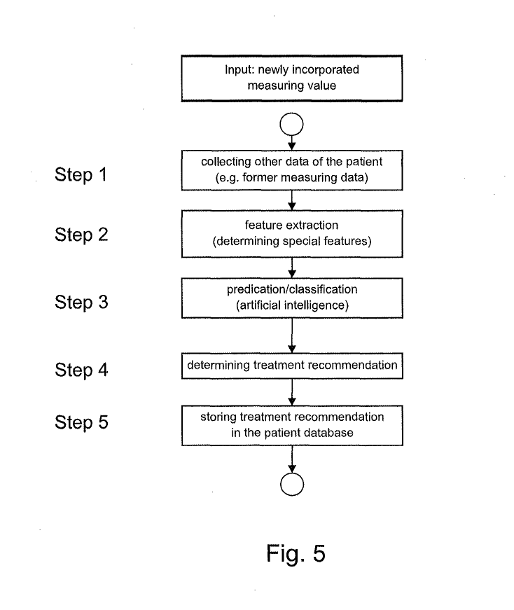

Depending on the type of measuring value, different methods can be used while the steps 2 and 3 in FIG. 5 are carried out.

Concerning blood pressure measuring values it is interesting, for example, to observe them in the progression and possibly predict them so as to recommend, based on the value, e.g., a particular ultrafiltration profile, during the next treatment.

Concerning a weight measuring value it is interesting, for example, to observe the same over plural therapies. If not always the same reduction to a particular established weight takes place, it can be recommended to increase the ultrafiltration volume.

When an increased blood sugar count is measured over the course of the dialysis treatment, a particular diet can be recommended. When the blood sugar value has normalized again to a lower level, e.g. the diet can be stopped again.

When an increased sodium level is measured or when an increasing tendency of the sodium level is detected, an appropriate diet in combination with a particular electric conductivity (of the blood or the dialysis fluid) can be recommended.

Therefore, inter alia, the following analysis methods are interesting:
Automatic model formation (by simple processes but also by artificial intelligence)
Determining peculiarities (features) of a number of measuring values such as mean value, standard deviation, variance, frequency information (FFT)=Fast Fourier Transformation
Prediction of models, time series of measuring values
Recommendation of treatments e.g. via decision trees or classification methods
Comparison of the data to other patient data so as to determine a possible treatment.

Consequently, by applying the afore-mentioned analysis methods to the measuring values of the patient a treatment recommendation can be determined. The latter is stored on the patient server and is made available to the physician or the patient for appropriately adapting the therapy.

1-16. (canceled)

17. A patient data monitoring system for central monitoring of at least one vital parameter of at least one dialysis patient in a therapy-free interval, comprising:
a central patient database for storing patient data of a patient which can be viewed at any time via a communication interface by at least one of physicians, hospital staff members or the patient;
at least one measuring device carried along or kept at home by the patient in the therapy-free interval for measuring at least one vital parameter of the at least one patient; and
a portable data processing and communication device carried along or kept at home by the at least one patient in the therapy-free interval which assigns a particular patient ID to each measured vital parameter obtained via a data connection from the at least one measuring device, automatically establishes a remote data connection to the central patient database and, once the remote data connection to the central patient database is established, automatically transmits a data set including the particular patient ID and the at least one measured vital parameter to the central patient database.

18. The patient data monitoring system according to claim 17, wherein the data processing and communication device includes means allowing distinction of plural patients who make use of the data processing and communication device for central monitoring of vital parameters and assigns an unambiguous patient ID to each individual patient.

19. The patient data monitoring system according to claim 17, wherein the data processing and communication device is configured to enable communication with a plurality of measuring devices and sensors.

20. The patient data monitoring system according to claim 17, wherein the data processing and communication device includes means allowing identification of the patient by way of biometric data.

21. The patient data monitoring system according to claim 17, wherein the data processing and communication device includes at least one of a camera, or a finger print sensor or a voice recognition means for identification by way of biometric data.

22. The patient data monitoring system according to claim 17, wherein the data processing and communication device includes means which allow adding information about at least one of the time of measurement or the location of measurement to the patient data set including vital parameters and identification data.

23. The patient data monitoring system according to claim 17, wherein the patient database is configured to carry out at least one of an analysis or an evaluation of the patient data stored in the patient database and belonging to the patient on the basis of a vital parameter newly received from the same patient.

24. The patient data monitoring system according to claim 23, wherein the patient database is configured to store the result of at least one of the analyzed or the evaluated patient data on the patient database so that the result is assigned to the particular patient.

25. A method for central monitoring of at least one vital parameter of at least one dialysis patient in a dialysis-free interval comprising the steps of:
a) establishing a connection between at least one sensor or measuring device for measuring at least one vital parameter to a data processing and communication device;
b) measuring at least one vital parameter of the patient by the at least one sensor or measuring device in the dialysis-free interval;
c) transmitting the measured value to the data processing and communication device;
d) assigning a patient ID corresponding to the patient to each measured vital parameter on the data processing and communication device;
e) checking and automatically setting up a remote data communication with a central patient database by the data processing and communication device;
f) automatically transmitting a data set including the patient ID and the at least one measured vital parameter from the data processing and communication device to the central patient database, once the connection to the central patient database is set up; and
g) storing the data set as patient data in the central patient database so that said data set can be viewed at any time by at least one of physicians, hospital staff members or the patient via a communication interface.

26. The method according to claim 25, wherein the method additionally comprises the step of the patient registering with the data processing and communication means.

27. The method according to claim 25, wherein the method step d) is carried out by the at least one sensor or measuring device for measuring the at least one vital parameter.

28. The method according to claim 25, wherein the method step d) is carried out by detecting biometric data of the patient and assigning the ID in accordance with the detected biometric data.

29. The method according to claim 25, wherein the method additionally comprises the step that the data are intermediately stored in the data processing and communication device and, after successful transmission to the central patient database, are deleted from the data processing and communication device.

30. The method according to claim 25, wherein the method step d) additionally comprises the step that metadata are added to the data set of the patient by the data processing and communication device, the metadata comprising at least one of time or location data.

31. The method according to claim 25, wherein the method additionally comprises the step of encoding the data of the data set including the patient ID and vital parameters.

32. The method according to claim 25, wherein in the method step e) a connection to a secure database server is set up.

33. The method according to claim 25, wherein in the case of failure of the method step e), step e) is automatically repeated to establish the connection until the transmission has been successful.

34. The method according claim 25, wherein the method additionally comprises the step of: providing a treatment recommendation corresponding to the patient data stored on the patient server, wherein the stored patient data includes at least one of data collected during the dialysis-free interval or the data collected during therapy and stored on the patient server.
